(19) United States
(12) Patent Application Publication
(10) Pub. No.: US 2006/0150477 A1
(43) Pub. Date: Jul. 13, 2006

(54) System for the care and protection of plants with roots

(76) Inventor: Brian James Mayer, Santa Cruz, CA (US)

Correspondence Address: Walt Froloff, 273D Searidge Rd, Aptos, CA, 95003, US

(21) Appl. No.: 11/034,481

(22) Filed: Jan. 12, 2005

(51) Int. Cl. A01G 9/02

(52) U.S. Cl. 47/32

(57) ABSTRACT

A system to provide protection for plant roots and bulbs from burrowing animals is presented. Body of system is manufactured as a single contiguous part, which in certain embodiments is flat for the cheapest manufacture and storage. In such embodiments, the part is wrapped, before installation, about an axis to form a conical-annulus with a bottom closure structure. In other embodiments, the part is manufactured in its installation form. An upper portion of the structure incorporates a mechanism by which the plant protection system is rigidly integrated with irrigation/nutrient delivery system. Lower portion of structure is perforated to allow for root growth and drainage while still providing protection of bulb or plant root core.

### BACKGROUND OF THE INVENTION

1. Field of the Invention

The present invention relates generally to a structure that provides protection for plant roots and bulbs from burrowing animals and allows integration with irrigation/nutrient delivery systems. Furthermore, the present invention is directed to a product that may be inexpensively manufactured, efficiently stored, quickly assembled, and easily installed and removed for reuse.

2. Background

The invention relates to a system that provides protection for plant roots and bulbs from burrowing animals. Furthermore this system provides for a rigid and fixed connection between the plant and irrigation/nutrient delivery systems.

The loss of plants to burrowing gophers, moles, rodents and such pests can be an expensive and an emotionally distressing experience. In some cases, plant roots and bulbs are consumed, leaving the upper portions of the plant to wither and die. In other cases, the pest consumes the entire plant, leaving only a small mound of dirt where the plant once stood. In either case, the damage is complete.

Furthermore, proper and efficient irrigation of plants requires that the orientation of an irrigation system remain fixed in relation to the plant. Thus a rigid structure in which the plant is buried, and which provides a means of attaching to irrigation lines, is needed.

Inventions addressing burrowing pests are either expensive, complicated, require excessive labor, are subject to material degradation in the soil, and/or are not readily integrated with existing irrigation systems. What is needed is a simple, easy, and inexpensive means of protecting the core root structure of individual plants. Such an invention must be inexpensive to manufacture, distribute, store, and install.

Inventions addressing some the above problems mentioned above have been proposed. These all suffer from relatively high cost, lack of integrated solution, assembly complexity, manufacturing expense, material degradation in the soil or lack of installation ease or are not easily reused. What are needed are solutions that are well integrated, cheap to manufacture, apply materials that are not chemically reactive in soils and are relatively inexpensive to manufacture, distribute, store and install.

There are several examples of plant root protection devices, one being U.S. Pat. No. 6,067,752, issued to Bryan, et al. The '752 design uses a rigid mesh with a plurality of discrete fins around the periphery of the top edge of the cage and a stabilizing strut attached to a side wall of the protective cage. The fins and struts make this a complicated design which is relatively expensive because of the complexity and also tougher to store and install because the wire mesh is collapsible and fatigues. Also wire meshes degrade and rust, becoming weaker and penetrable with time.

An example of another plant root protection system is U.S. Pat. No. 5,495,692, issued to LoJacono, Jr. '692 claims a collapsible wire basket structure to surround the plant root for protection. Collapsible wire mesh makes installation more difficult and also adds size requirements for storage or distribution of wire mesh protection schemes. Moreover, metal wire mesh is relatively expensive and subject to rust in the hostile ground environment. Wire mesh solutions are therefore ill suited for reuse. Furthermore, '692 claims a “plurality of annularly interlinked sinusoidal wire strands defining a circumferential side wall and a bottom wall, said sinusoidal wire strands being loosely woven and connected to an upper annular support ring” in its design. The sinusoidal wire strands defining the circumferential sidewall would only add to the cost of manufacture, storage, distribution, storage and installation of this plant root protection device.

Another example of a plant protection system is U.S. Pat. No. 4,955,156, Williams et al., “Plant watering and root protection device”. '156 uses a “vertically-elongated sheet of stiff material forming continuous annular sheath for underground encircling of said plant root system” While the stiff material on the annulus body is preferable to mesh, '156 uses a mesh bottom. A mesh bottom different from the annular body in material and construction poses the disadvantage of additional assembly of dissimilar parts, rusting of bottom mesh, weakened security, fastening or connecting a bottom with dissimilar construction from body, and higher manufacturing costs with the mesh, additional pieces and assembly. '156 also has a top piece with a “curvilinear edge adapted with a continuous groove extending along the entire length of said curvilinear edge forming a berm” The curvilinear edge with groove adds cost to manufacturing while making it more difficult for adapting plant watering lines and other utility devices with snap on attachments. Further more, '156 uses “interlocking engaging means for engaging and interlocking with a corresponding interlocking engaging means on a vertical edge of another of said pieces.” This design while having the advantage of rigid annular body, suffers from assembly of pieces, cost of curvilinear berm and retains the disadvantage of a mesh bottom.

Interlocking mechanisms add assembly effort to an already labor intensive job. Locking mechanisms may be hard to lock depending on the design or become unlocked during installation or ground soil shifting producing protection breach into the root volume and/or providing limited protection from body-bottom mesh separation. What is needed is a simpler cheaper well-integrated design without unjustified interlocking parts, or designs, which add material cost and difficulty in storage and installation, and not designs that have corrodible mesh bottoms or sides.

### OBJECTS AND ADVANTAGES OF THE INVENTION

It is therefore the object of the present invention to provide an inexpensive protection system for plant roots and bulbs from burrowing animals.

It is also the object of this invention to provide such a system that is easy to install and requires little or no assembly.

It is also the object of this invention to provide such a system that is reusable.

It is further the object of this invention to provide a plant root and bulb protection system that can be manufactured cheaply in large quantities for use in commercial agricultural applications.

It is further the object of this invention to provide a plant root and bulb protection system that can be stored and stacked in a space-saving manner when not in use.

It is further the intent to provide a simple means of integrating this plant root and bulb protection system with an irrigation and or nutrient delivery system.

It is further the object of this invention to provide a plant root and bulb protection system that does not readily degrade in the ground from rust or material interaction with soil chemistry.

These objects of the invention will be apparent from the following description as compared with ordinary skill in the art.

### SUMMARY OF THE INVENTION

The above desirable features of a plant cultivation and protection system are provided in accordance with the present invention which, briefly stated, in a preferred form, comprises a plant root protection and plant utility system adapted for protecting roots from underground pests and for supporting plant care utility.

The invention is a single, rigid, contiguous part comprised of an upper, aboveground, portion and a lower, belowground, portion. The top of the upper portion is open, allowing the above ground structure of the plant to grow unobstructed. The upper portion is of larger cross section as compared with the lower portion thus providing increased surface area to prevent the structure and protected plant from being pulled underground by burrowing predator. The upper portion incorporates slots in which pin assemblies, designed to connect irrigation/nutrient delivery systems, are inserted.

The lower portion of the structure is perforated on its sides and bottom to allow for root growth and drainage while protecting the plant's core root structure or bulb. The structure is composed of materials thick enough to prevent burrowing animals from penetrating the structure. All below ground perforations are small enough to prevent access of burrowing animal.

Embodiments of this invention incorporate structures affixed to the bottom that facilitate installation of invention in soil. Some embodiments are manufactured in their installation form, while other embodiments are manufactured flat and must be wrapped into their conical annulus with bottom shape for before installation.

### BRIEF DESCRIPTION OF THE DRAWINGS

FIG. 1 is an isometric view of the preferred embodiment of the plant protection and cultivation utility system according to the invention.

FIG. 2 is a bottom view of the preferred embodiment in FIG. 1.

FIG. 3 shows an embodiment irrigation system clip attachment

FIG. 4 is a top view of the preferred embodiment with an irrigation tube supported by plant utility system clips inserted into the plant protection base in accordance with the preferred invention.

FIG. 5 is front view of the preferred embodiment of the plant protection system with a wedge bottom design in accordance with the invention.

FIG. 6 is a top view of a the wedge bottom embodiment of FIG. 5

FIG. 7 is front view of the preferred embodiment of the plant protection system with an impeller bottom design in accordance with the invention.

FIG. 8 is a top view of the openings on the bottom portion of the impeller bottom embodiment shown in FIG. 7

FIG. 9 is a bottom view of an impeller bottom design of FIG. 7

FIG. 10 is a top view of a simple manufacturing flat mold embodiment of the plant protection system in accordance with the invention.

FIG. 11 is and isometric view of the assembly character of a simple flat mold manufacturing embodiment in FIG. 10.

FIG. 12 is and isometric view of a four facet four side plant protector and care system in accordance with the invention.

### DETAILED DESCRIPTION OF THE PREFERRED EMBODIMENTS

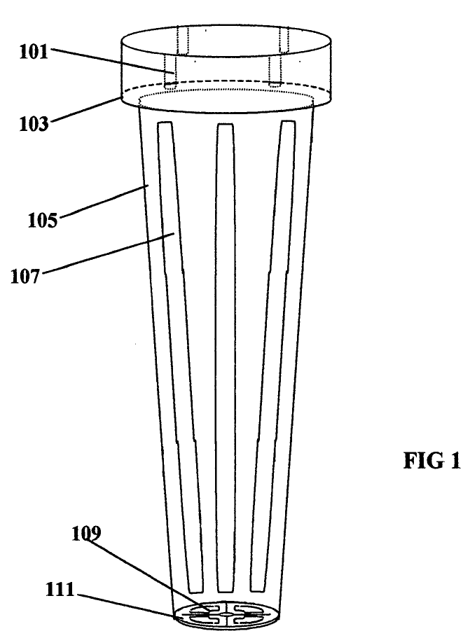

An isometric view of a preferred embodiment of the plant protection and cultivation utility system according to the invention is shown in FIG. 1. The plant protection system is a single piece forming a substantially continuous annular sheath body 105 surrounding the plant roots. The body portion 105 surrounding the plant roots contains water drainage slots 107 extending along the body sides from near the top edge to the bottom edge of the plant protection system. The width dimensions of the drainage slot 107 are sufficiently narrow to prevent a pest from obtaining access to the main plant root system. Although this embodiment is described as with an annular geometry surrounding the plant and plant root system, it is more generally claimed for a rigid planar structure with contiguous subsurface and above ground surface portions surrounding plant root system volume and not limited to an annular design. For example a tapered facet design may function well in some instances where landscaping dictates a more angular shape or planting areas are to be more completely covered and the circular above surface structure would leave more surface ground under-utilized.

The upper edge 103 comprises a protective barrier of radius circumferentially outward from the plant annular axis, upper plant protector edge lays flush with the ground surface providing surface resistance from pest attempts at pulling the plant protection system below and for providing a water-pooling region encompassing the plant surface area above the root system. An upper edge portion 104 is bent away from the flush upper edge portion 103 to a substantially vertical extension 104 providing a slow draining reservoir for shallow water-pooling region encompassing the plant surface area above the root system and for utility attachment openings 101. In other embodiments, the upper edge above surface height portion design may be adjustable in height through an sliding extension or telescoping surface to ground surface level. Height adjustments may be necessary to accommodate attachable plant cultivation systems and devices for watering, surface elevation differences, long spans with line sag, certain pest obstruction and other needs that may arise.

The bottom 111 of the plant protection device is as shown with four radial trapezoid slots 109 and a circular perforation at the center for drainage from the bottom away from the plant roots. The number and shape of the bottom openings is not material save that their dimension be sufficiently small to present a barrier to burrowing pests but sufficiently large to allow adequate drainage.

Depending on the thickness and stiffness of the annular body and bottom material, the protection system may simply be inserted into the ground hole using the bottom edge of the protection system and driving the system into the soil in any convenient manner, positioning the upper plant protection annular structure above the soil. The single rigid above ground portion structure contiguous with a subsurface non-mesh construction allows for root growth and drainage and small enough to prevent access of burrowing pests while allowing reasonable reuse of the system in replanting because the non-mesh construction allows the root and bulb to be excavated from the ground without injury to the plant and without degradation generally affecting mesh designs.

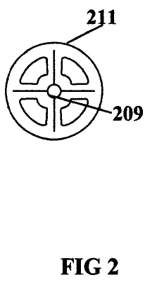

FIG. 2 is a view of the bottom 211 of the preferred embodiment shown in FIG. 1 and shows the openings 209 at the center as well as four quadrant openings. As above, the size and shape of the openings are adjusted for pest size to prevent penetration of the protection system.

It will be appreciated that this embodiment may be made in several sizes to accommodate the differences in plant sizes, expected growth rates of root structures and root system and cultivation schemes. Thus a strawberry plant may require a different size than carrots etc. Many different materials can be used spanning from sheet metal to plastics. Thus it could be made of durable plastic or corrosion-resistant metal. The cheapest and most durable material may be a type of plastic. Since the protection device subsurface body portion may be thin sheet barriers without the requirement to structurally support itself. Thus the underground body wall need not be made for structural support as for resistance to pest incisors and means used to gain access to plant roots.

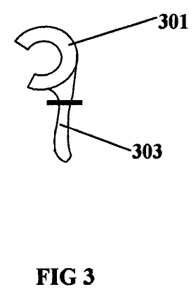

An irrigation system clip attachment device for insertion into the plant protection upper, above ground, annular edge surrounding the plant is shown in FIG. 3. The minimum circumference of a clip attachment device 301 is preferably as large as the maximum expected or desired circumference defined by the drip line of the plant irrigation or cultivation system. Thus, it will be appreciated that the clip attachment 303 may be made in several convenient sizes to accommodate the size of common irrigation system sizes. The clip attachment 303 may be utilized either when the plant is first buried in the ground or may be inserted at a later date into the plant protection system after the plant has been established to accommodate the plant life cycle as well as external conditions such as weather, water needs, pest control and others.

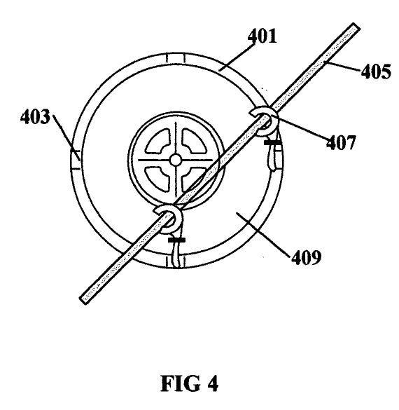

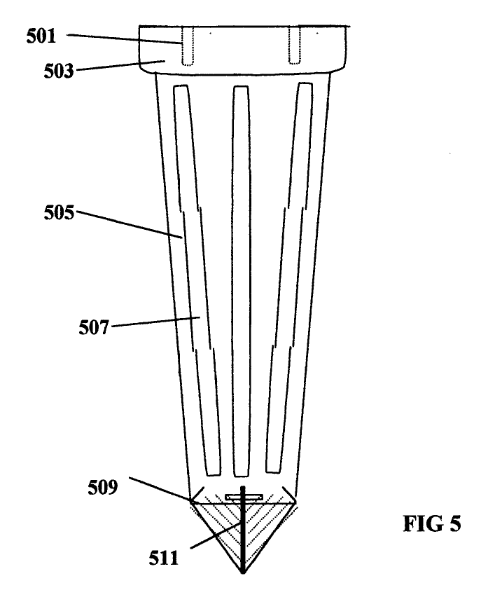

FIG. 4 is a top view of the preferred embodiment with an irrigation tube supported by plant utility system clips inserted into the plant protection base accordance with the preferred invention. The protector system body 409 contains annular slot length perforations 413 and the above ground protector lip 401 which can repel surface insects, snails and slugs as well as keep a reservoir of water to drain drip fashion more effectively and with less wasted water than plants without the system.

Where labor is a time and expense factor, quick and efficient installation of plant protection devices and systems demands special care in design. FIG. 5 is front view of the preferred embodiment of the plant protection system with a wedge bottom design in accordance with the invention. The above ground upper portion 503 of the preferred embodiment contains the attachment insertion holes 501 which need not be cylindrical but any geometry which firmly mate with the attachment clips which hold and support cultivation utilities such as irrigation water. The annular body 505 contains drainage slots 507 which may be configured in many other geometries and shown here as running directly parallel to the body for convenience. The base bottom 509 of the preferred embodiment supports a wedge 511 to more easily facilitate the driving of the plant protector into a ground hole thereby decreasing the labor and time necessary to install the plant protection system.

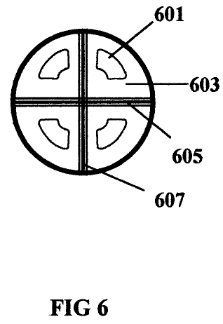

FIG. 6 is a top view of the embodiment shown in FIG. 5 but with a wedge base bottom 603 implementation. The wedge blades 605 607 are shown perpendicular to each other but need not be so oriented. A continuum of angles between the blades is possible and individual blade decent angles themselves can vary. Additional wedge blades can also be added for easier installation. The base bottom has openings 601 shown but may have the openings on the annulus body side bottoms as well, to allow drainage from the plant protection system.

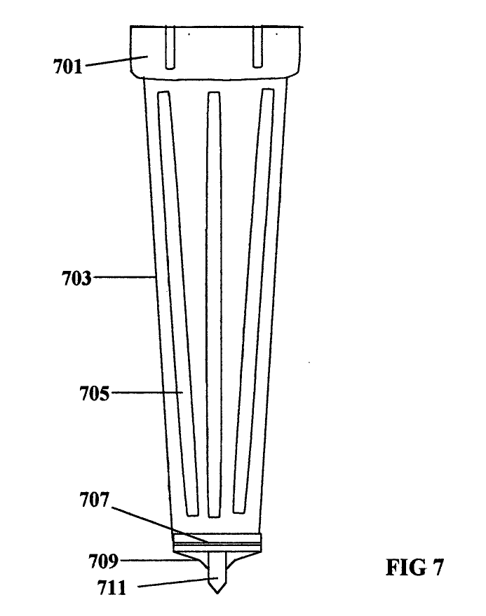

FIG. 7 is front view of the preferred embodiment of the plant protection system with an impeller bottom design in accordance with the invention. The upper 701 above ground portion of the system is contiguous to the annular body 703 which has slot 705 drainage perforations running the length of the annular body. As with other embodiments, the perforations can be of other geometric polygons and are not constrained to a rectangular lengthwise perforation. The embodiment bottom design contains an impeller like structure 709 coming to a point 711 on a bottom base plate 707. The installation will be facilitated by a twisting insertion of the plant protector and would in thus fashion save time and effort.

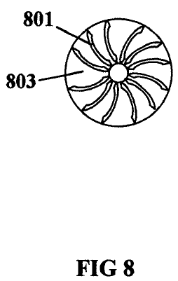

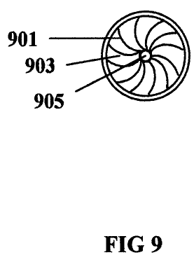

FIG. 8 is a top view of the openings on the bottom portion of the impeller bottom embodiment shown in FIG. 7, the crescent openings allowing drainage between the impellor like structure adjacent to and below the base plate. FIG. 9 is a bottom view of an impeller bottom structure shown in FIG. 7, with the impellor blade 901 structures interspersed with crescent openings 903 merging at a cylindrical rounded point to facilitate installation of the plant protection system.

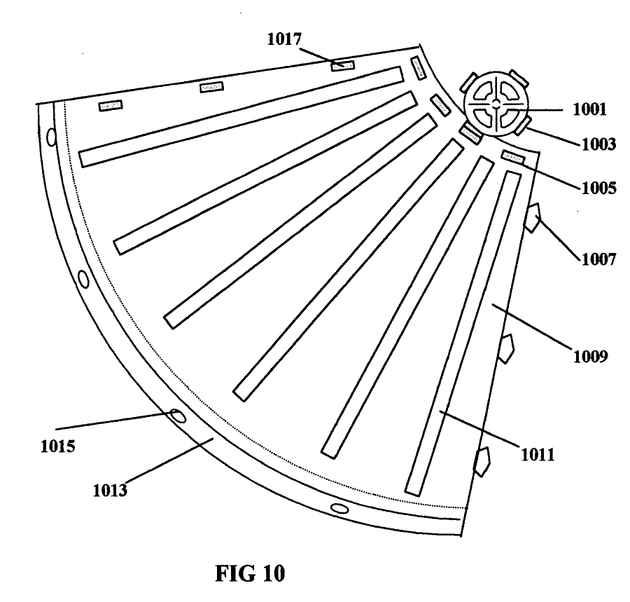

Referring to FIG. 10 there is shown a top view of a simple manufacturing flat mold cast embodiment of the plant protection system in accordance with the invention. Manufacturing costs increase with an increase in number of components and component dimensions, folds and complexity. FIG. 10 shows a flat mold cast that is a single piece, approximately two dimensional and very plain. These can be “stamped” out in economic single piece quantities quickly and inexpensively, allowing for the advantage of cost where it was prohibitive before or not competitive with other plant protection systems. The simple flat embodiment includes the bottom attachable piece 1001 which may be manufactured as one contiguous piece and assembled together with the male 1003 and female 1005 attachment snaps. The annular body 1009 would be manufactured flat for the purposes stated above and would have perforations 1011 for water drainage when the body is furled into is annular installation configuration. The furl would be around its longitudinal axis and connected via male attachments 1007 to female attachments 1017 or a comparable snap mechanism. The upper protection system 1013 is contiguous to the subsurface body portion 1009 but would be positioned to extend above the surface to create a small-enclosed area surrounding the plant to be protected. This upper portion 1013 would contain the hole attachments 1015 for attachment clips for use in various utilities for plant care as discussed in the above embodiments.

In another embodiment, the bottom piece 1001 can be a foldable extension of the flat annular body 1109 cast, a bottom section 1103 which can fold into the bottom position with the body bottom mating attachment 1105, flat body furling around it's longitudinal axis and securing the bottom section firmly to the bottom of the annular body 1009 portion to complete the assembly with the other bottom 1003 1005 attachments and annular body side attachments 1007 1017 aligned in such manner to snap or attach the sections firmly for installation.

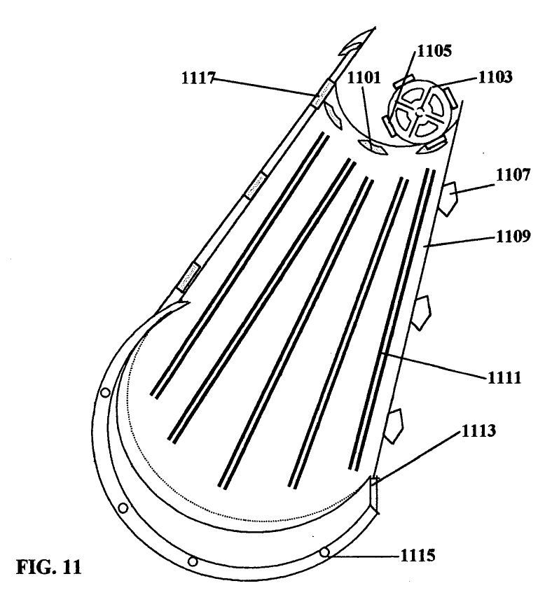

FIG. 11 is and isometric view of the assembly character through furling a simple flat cast manufacturing embodiment 1109 in FIG. 10 around its axis centered through and perpendicular to the bottom piece 1103, interlocking male attachment 1105 to the plant protector body slot snap female 1101 at bottom of annular body 1109. Similarly interlocking the side edge mating attachments 1107 1117, side edges which may or may not be vertically implanted on the ground. As in the above preferred embodiment, similar slots 1111b traverse the annular body 1109 for drainage purposes and the annular upper edge 1113 for above surface protrusion contains utility holes 1115 for

It will be appreciated that there are numerous ways for securely engaging and interlocking edge mating pieces at their vertical edges into one annular protection system and the present invention is not limited by the annulus side edge securing devices shown in FIGS. 10 and 11. The annulus side edge and bottom attachment part gender are interchangeable and can vary in type and number to form an assembly simple to complete and system easy to install.

It is preferred that the plant protection system be formed of one piece, each of which can be individually molded without attaching or affixing parts by gluing, brackets, screws, clips, etc. Thus as shown in FIGS. 10 and 11, can be molded from a single mold without the necessity of attaching interlocking devices, thus making assembly easily and manufacturing economical, precluding any additional steps or pieces in assembly or manufacturing.

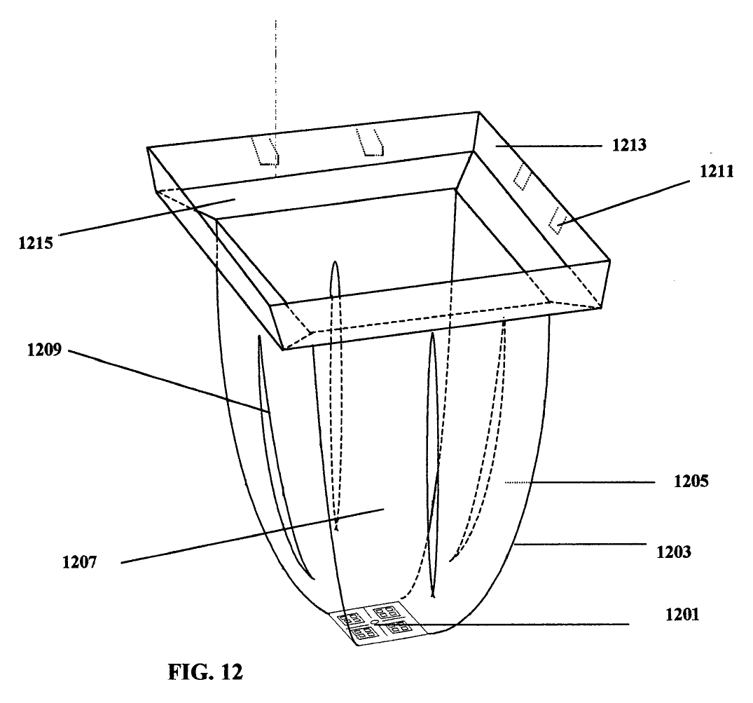

FIG. 12 is an isometric view of a four facet, four-sided plant protector and care system in accordance with the invention. FIG. 12 illustrates plant protection and care system design with a three dimensional planar structure composed of a rigid short four-sided wall 1213 portion complete with insert devices 1211 for plant cultivation utilities integrated into the sidewalls. This wall side portion surrounding the plant above ground is contiguous with a square ring 1215 substantially flat against the ground surface which is contiguous with four tapered plane surfaces contiguously forming a faceted subsurface body 1203 portion more or less axi-symmetric with plant axis, the four tapered planar surfaces 1205 1207 contiguous to a bottom surface 1201 portion all forming one piece and substantially enclosing the plant root system.

The front subsurface side 1207 and the right subsurface side 1205 meet at an edge 1203 and likewise the other subsurface tapered sides meet at edges forming one complete piece. Each subsurface side of the body portion 1203 surrounding the plant roots contain water drainage perforations 1209 extending along the planar tapered facet body sides from near the top edge to the bottom 1201 edge of the plant protection system. The width dimensions of the drainage slot 1209 are sufficiently narrow to prevent a pest from obtaining access to the main plant root system.

The upper portion 1213 comprises a short wall protective barrier surrounding the plant main stem outward from the plant main stem axis, a portion of the upper plant protector wall is supported by and contiguous with square ring 1215 portion which is flush with the ground surface when system is installed, providing surface resistance from pest attempts at pulling the plant protection system below and with the contiguous short wall 1213 for providing a water-pooling region encompassing the plant surface area above the root system. An upper edge portion 1213 is bent away from the flush upper edge portion 1215 to a substantially vertical extension providing a slow draining reservoir for shallow water-pooling region encompassing the plant surface area above the root system and for utility attachment openings 1211.

The bottom 1201 of the plant protection device is as shown with perforations for drainage from the bottom away from the plant roots. The number and shape of the bottom openings are not material save that their dimension be sufficiently small to present a barrier to burrowing pests but sufficiently large to allow adequate drainage.

Thus, extrapolating on the number of sides on a plant protection and care system in FIG. 12, we can increase the sides and corresponding subsurface planar facets of the system further comprising a rigid three dimensional planar structure comprised of an N sided polygon short wall surrounding the plant with an above ground surface portion contiguous with a substantially axi-symmetrical N tapered plane surfaces contiguously forming a faceted subsurface body portion, N tapered planar surfaces contiguous to a bottom surface substantially enclosing the plant root system and forming one piece.

While the invention has been described in detail with reference to preferred embodiments, it is understood that variations and modifications thereof may be made without departing from the true spirit and scope of the invention.

What is claimed is:

1. A system for protecting plant roots and bulbs comprising:
a single contiguous structure with above ground portion and contiguous subsurface portion surrounding the plant root or bulb, enclosing it, thus providing protection from burrowing animals,
wherein the subsurface portion incorporates perforations large enough to allow for root growth and drainage and small enough to prevent access of burrowing pests.

2. A plant root and bulb protection system according to claim 1 wherein the above ground portion incorporates attachment artifacts for connecting the system to irrigation/nutrient delivery systems.

3. A plant root and bulb protection system according to claim 1 wherein the above ground portion is of larger cross section than the subsurface portion thereby providing increased ground surface area to resist structure and enclosed plant from being pulled under by burrowing animal.

4. A plant root and bulb protection system according to claim 1 wherein the system is formed into its assembled three-dimensional shape.

5. A plant root and bulb protection system according to claim 1 wherein the system is formed as a flexible flat part which is assembled prior to use by wrapping side edges about the longitudinal axis and connecting side edges for a rigid contiguous structure.

6. A plant protection system according to claim 5 further comprising an enclosing three dimensional surface structure body with interlocking engaging attachments comprising a male tab on a first side edge and a corresponding female receptacle on the second side edge, said tab and receptacle being adapted to securely interlock together to hold the edges securely with each other forming a three dimensional planar structure for substantially enclosing the plant root system.

7. A plant protection system subsurface portion according to claim 1 further comprising an impeller bottom or of ground insertion wedge shape bottom design for easing installation.

8. A plant protection system according to claim 1 further comprising single rigid structures of cylindrical, conical section, or n-sided geometric three-dimensional surface shapes.

9. A plant protection system upper portion as in claim 1 further comprising above surface height placement adjustable to ground surface level for attachable plant cultivation systems and devices for watering, feeding or chemical delivery systems, and the above surface plant protection system portion enclosing an area above the plant roots system surrounding the plant main stem directing drainage into root system.

10. A plant protection system according to claim 1 further comprising vertically oriented perforations along the length the subsurface portion.

11. A system for protecting plant roots and bulbs and with cultivation utility attachments comprising:
a single rigid above ground portion structure contiguous with a subsurface portion constructed of non-mesh material surrounding the plant root or bulb,
wherein the subsurface portion incorporates perforations large enough to allow for root growth and drainage and small enough to prevent access of burrowing pests while providing reasonable reuse of system in replanting.
